(19) United States
(12) Patent Application Publication
(10) Pub. No.: US 2013/0122418 A1
(43) Pub. Date: May 16, 2013

(54) Alkyl Benzene Sulfonate Surfactant Having An Ammonium Salt Counter Ion For Reduced Sodium Content In Emulsions

(71) Applicants: Kimberly D. Nosella, Mississauga (CA); Shigang S. Qiu, Toronto (CA); Santiago Faucher, Oakville (CA); Allan Chen, Oakville (CA)

(72) Inventors: Kimberly D. Nosella, Mississauga (CA); Shigang S. Qiu, Toronto (CA); Santiago Faucher, Oakville (CA); Allan Chen, Oakville (CA)

(73) Assignee: Xerox Corporation, Norwalk, CT (US)

(21) Appl. No.: 13/293,335

(22) Filed: Nov. 10, 2011

(51) Int. Cl. G03G 9/08; G03G 9/16

(52) U.S. Cl. 430/137.14; 430/137.1

(57) ABSTRACT

A process including contacting an alkyl benzene sulfonate surfactant having an ammonium salt counter ion with a component to be emulsified or dispersed, wherein the alkyl benzene sulfonate surfactant is substantially free of sodium salt counter ions such that the sodium content of the alkyl benzene sulfonate surfactant is less than about 5,000 parts per million, and water to form a mixture; using the alkyl benzene sulfonate surfactant to emulsify the component and form an emulsion; or using the alkyl benzene sulfonate surfactant to disperse the component and form a dispersion.

### BACKGROUND

The present disclosure relates to alkyl benzene sulfonate surfactants having an ammonium salt counter ion. In embodiments, the present disclosure relates to processes comprising contacting an alkyl benzene sulfonate surfactant having an ammonium salt counter ion with a resin, a wax, or a pigment, and using the alkyl benzene sulfonate surfactant to emulsify the resin and form a resin emulsion, using the alkyl benzene sulfonate surfactant to disperse the wax and form a wax dispersion, or using the alkyl benzene sulfonate surfactant to disperse the pigment and form a pigment dispersion. In certain embodiments, the present disclosure relates to emulsifiable resin granules prepared with alkyl benzene sulfonate surfactants having an ammonium salt counter ion which granules are useful for preparing latex emulsions which in turn can be used for the preparation of toners.

Numerous processes are within the purview of those skilled in the art for the preparation of toners. Emulsion aggregation (EA) is one such method. Emulsion aggregation toners may be used in forming print and/or xerographic images. Emulsion aggregation techniques may involve the formation of an emulsion latex of the resin particles by heating the resin, using a batch or semi-continuous emulsion polymerization, as disclosed in, for example, U.S. Pat. No. 5,853,943, which is hereby incorporated by reference herein in its entirety. Other examples of emulsion/aggregation/coalescing processes for the preparation of toners are illustrated in U.S. Pat. Nos. 5,278,020, 5,290,654, 5,302,486, 5,308,734, 5,344,738, 5,346,797, 5,348,832, 5,364,729, 5,366,841, 5,370,963, 5,403,693, 5,405,728, 5,418,108, 5,496,676, 5,501,935, 5,527,658, 5,585,215, 5,650,255, 5,650,256, 5,723,253, 5,744,520, 5,763,133, 5,766,818, 5,747,215, 5,804,349, 5,827,633, 5,840,462, 5,853,944, 5,869,215, 5,863,698, 5,902,710, 5,910,387, 5,916,725, 5,919,595, 5,925,488, 5,977,210, 5,994,020, and U.S. Patent Publication 2008/0107989, the disclosures of each of where are hereby incorporated by reference herein in their entireties.

Polyester toners exhibiting low melt properties have been prepared utilizing amorphous and crystalline polyester resins as illustrated, for example, in U.S. Patent Publication 2008/0153027, which is hereby incorporated by reference herein in its entirety.

Polyester toners have been prepared using polyester resins to achieve low melt behavior, enabling faster print speeds and lower energy consumption. However, the incorporation of these polyesters into the toner requires that they first be formulated into latex emulsions prepared by solvent containing processes, for example, solvent flash emulsification and/or solvent-based phase inversion emulsification. In both cases, large amounts of organic solvents such as ketones or alcohols have been used to dissolve the resins, which may require subsequent energy intensive distillation to form the latexes, and may require the removal of residual solvent from waste waters in the toner making process. These processes are thus not environmentally friendly. Solventless latex emulsions have been formed in either a batch or extrusion process through the additional of a neutralizing solution, a surfactant solution, and water to a thermally softened resin, as illustrated, for example, in U.S. Patent Publication 2009/0208864, which is hereby incorporated by reference herein in its entirety, and U.S. Patent Publication 2009/0246680, which is hereby incorporated by reference herein in its entirety.

U.S. Patent Publication 2011/0027710, of Santiago Faucher, et al., entitled “Self Emulsifying Granules And Process For The Preparation Of Emulsions Therefrom,” which is hereby incorporated by reference herein in its entirety, describes in the Abstract thereof a process for making a self-emulsifying granule suitable for use in forming latex emulsions including contacting a resin with a solid or highly concentrated surfactant, a solid neutralization agent and water in the absence of an organic solvent to form a mixture, melt mixing the mixture, and forming self-emulsifying granules of the melt mixed mixture. Self-emulsifying granules are also provided and configured to form a latex emulsion when added to water, which may then be utilized to form a toner. See also U.S. Patent Publication 2011/0028570, of Santiago Faucher, et al., entitled “Self Emulsifying Granules And Process For The Preparation Of Emulsions Therefrom,” which is hereby incorporated by reference herein in its entirety.

U.S. patent application Ser. No. 13/014,028, of Allan K. Chen, et al., entitled “Solvent-Free Toner Processes,” which is hereby incorporated by reference herein in its entirety, describes in the Abstract thereof processes for producing toners. In embodiments, alkyl or alkyl ether sulfates are used in a solvent-free toner production process as surfactants to provide for higher parent particle charge without adversely affecting particle size, distribution control and circularity of the toner particles. The disclosure also provides a new formulation and process for the emulsification of polyester resins to form nano-scale particles dispersed in water (latex) without the use of organic solvents by an extrusion process.

It is known to use surfactants containing sodium salt counter ions to emulsify resins. For example, a compound of the formula

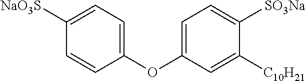

available commercially from Dow Chemicals USA as Dowfax® 2A1, and a compound of the formula

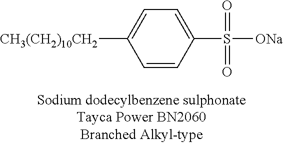

available commercially from Tayca Corporation as Tayca Power®, have been used as surfactants for use in toner preparation. Both of these surfactants, however, contain sodium salt counter ions that directly contribute to the overall sodium content present in the final toner. Sodium content can have a large effect on toner charging. The higher the overall sodium ion content remaining in the final toner, the lower the toner charge. By using additional washing steps and increasing water consumption, the quantity of sodium ions can be reduced. However, such processes can increase complexity and production cost.

The appropriate components and process aspects of the each of the foregoing U.S. Patents and Patent Publications may be selected for the present disclosure in embodiments thereof. Further, throughout this application, various publications, patents, and published patent applications are referred to by an identifying citation. The disclosures of the publications, patents, and published patent applications referenced in this application are hereby incorporated by reference into the present disclosure to more fully describe the state of the art to which this invention pertains.

Currently available toners and methods for preparing same are suitable for their intended purposes. However a need remains for an improved toner and an improved method suitable for preparing toners, including improved methods that can reduce the number of stages and materials required. Such processes may reduce production costs for such toners and may be environmentally friendly. It is known that increased sodium content in or on the toner surface can reduce toner charge which can lead to image quality and transfer issues. Previous methods to reduce sodium content include increasing water consumption during washing. Although such methods are suitable for their intended purposes, there remains a need for an improved method for reducing the sodium content in the upstream raw materials so that less sodium needs to be washed out in the downstream processes. There further remains a need for improved surfactants and methods for preparing same which can be used for the preparation of emulsions, pigment dispersions, and wax dispersion suitable for use in preparing materials such as toners.

### SUMMARY

Described is a process comprising contacting an alkyl benzene sulfonate surfactant having an ammonium salt counter ion with a component to be emulsified or dispersed, wherein the alkyl benzene sulfonate surfactant is substantially free of sodium salt counter ions such that the sodium content of the alkyl benzene sulfonate surfactant is less than about 5,000 parts per million, and water to form a mixture; using the alkyl benzene sulfonate surfactant to emulsify the component and form an emulsion; or using the alkyl benzene sulfonate surfactant to disperse the component and form a dispersion.

Also described is a process for preparing a toner comprising homogenizing a resin emulsion with an alkyl benzene sulfonate surfactant having an ammonium salt counter ion, wherein the alkyl benzene sulfonate surfactant is substantially free of sodium salt counter ions such that the sodium content of the alkyl benzene sulfonate surfactant is less than about 5,000 parts per million, a colorant, and an optional wax, with a coagulant to form a homogenized toner slurry comprising pre-aggregated particles at room temperature; heating the slurry to form aggregated toner particles; freezing the toner slurry once at the desired aggregated particle size; and further heating the aggregated particles in the slurry to coalesce the aggregated particles into toner particles.

Also described is a process for preparing an emulsifiable resin comprising contacting a resin with an alkyl benzene sulfonate surfactant having an ammonium salt counter ion, wherein the alkyl benzene sulfonate surfactant is substantially free of sodium salt counter ions such that the sodium content of the alkyl benzene sulfonate surfactant is less than about 5,000 parts per million, a neutralizing agent, and, optionally, water, in the absence of an organic solvent to form a mixture; melt mixing the mixture; and forming an emulsifiable resin from the melt mixed mixture; optionally, adding water to the emulsifiable resin to provide a latex emulsion containing latex particles; and optionally, continuously recovering the latex particles.

### BRIEF DESCRIPTION OF THE DRAWINGS

FIG. 1 is a graph showing particle size and standard deviation for solvent-free emulsifiable granules prepared in accordance with the present disclosure.

FIG. 2 is a graph showing particle size and standard deviation for comparative granules.

FIG. 3 is a graph showing particle size and standard deviation for solvent-free emulsifiable granules prepared in accordance with the present disclosure.

### DETAILED DESCRIPTION

The present disclosure provides alkyl benzene sulfonate surfactants having an ammonium salt counter ion and processes for using the alkyl benzene sulfonate surfactants comprising contacting an alkyl benzene sulfonate surfactant having an ammonium salt counter ion with a component selected from the group consisting of a resin, a wax, a colorant, although not limited thereto, and mixtures and combinations thereof, wherein the alkyl benzene sulfonate surfactant is substantially free of sodium salt counter ions such that the sodium content of the alkyl benzene sulfonate surfactant is less than about 5,000 parts per million, and using the alkyl benzene sulfonate surfactant to emulsify or disperse the component to form an emulsion or dispersion. That is, in embodiments, there is less than 5,000 parts sodium salt counter ions per 1 million parts total surfactant.

In some embodiments, the process herein comprises using the alkyl benzene sulfonate surfactant to emulsify a resin and form a resin emulsion.

In other embodiments, the process herein comprises using the alkyl benzene sulfonate surfactant to disperse a wax and form a wax dispersion.

In other embodiments, the process herein comprises using the alkyl benzene sulfonate surfactant to disperse a colorant and form a colorant dispersion. The colorant can be any suitable or desired colorant. In embodiments, the colorant can be selected from the group consisting of pigments, dyes, and mixtures and combinations thereof.

Resin emulsions herein can be prepared using any emulsifying technique known to one skilled in the art of making resin emulsions. For example, in embodiments, the process herein can comprise forming a resin emulsion by contacting the alkyl benzene sulfonate surfactant having an ammonium salt counter ion with resin, water, and other optional components as desired, and forming an emulsion using any suitable or desired emulsifying technique including, but not limited to, an emulsifying method selected from the group consisting of solvent flashing, phase inversion, and melt mixing. Optionally, the process can comprises adding one or more additional components to the resin emulsion.

In embodiments, the alkyl benzene sulfonate surfactant is used to emulsify a resin and the alkyl benzene sulfonate surfactant is present in an amount of from about 0.01% to about 30% by weight, based on the total weight of the resin.

The emulsifying process can be carried out for any suitable or desired period of time, such as from about 30 to about 120 minutes, or from about 35 to about 90 minutes, or from about 40 to about 75 minutes.

Colorant and wax dispersions herein can be prepared using any milling, blending or grinding techniques known to one skilled in the art of making colorant or wax dispersions. For example, in embodiments, the alkyl benzene sulfonate surfactant having an ammonium salt counter ion can be contacted with a colorant, such as a pigment, a dye, a mixture or combination of pigments, a mixture or combination of dyes, or a mixture or combination of pigments and dyes, and other optional components as desired and a dispersion formed using any suitable or desired method. In embodiments, a dispersion can be formed by using a media mill, piston or rotor-stator homogenizer, or other known dispersing tools.

Dispersing can be performed for any suitable or desired period of time. In embodiments, dispersing can be performed for from about 20 minutes to about 10 hours, or from about 30 minutes to about 7 hours, or from about 45 minutes to about 5 hours.

The present disclosure further provides processes for forming emulsifiable resin granules. The resin granules, in turn, may then be used to form a latex emulsion containing latex particles which may be used to make toners. The alkyl benzene sulfonate surfactant having an ammonium salt counter ion and process herein emulsifies similarly, if not better than, previous sodium-containing surfactants in a solvent free process. In certain embodiments, the resin emulsion herein can be prepared by melt mixing (solvent-free process). As noted above, resin emulsions herein can also be prepared by any suitable or desired emulsification technique, such as those described herein including, but not limited to, solvent flashing emulsification, phase inversion emulsification, and other known emulsification techniques, while employing the present alkyl benzene sulfonate surfactant having an ammonium salt counter ion.

In embodiments, a process of the present disclosure includes contacting a resin with an alkyl benzene sulfonate surfactant having an ammonium salt counter ion, wherein the surfactant is substantially free of sodium salt counter ions such that the sodium content of the alkyl benzene sulfonate surfactant is less than about 5,000 parts per million, a neutralizing agent, and optionally water to form a mixture; melt mixing the mixture; forming emulsifiable resin granules, such as self-emulsifying resin granules of the melt mixed mixture.

The self-emulsifying resin granules can be placed in deionized water, in embodiments in deionized water at a temperature of from about 80° C. to about 90° C., although not limited. The resultant emulsion can contain resin granules of any suitable or desired particle size, in embodiments of a volume average particle diameter of from about 30 nanometers to about 500 micrometers, from about 50 to about 350 nanometers, or from about 80 to about 250 nanometers, as determined, for example, by a Nanotrac particle size analyzer. In a specific embodiment, the emulsifiable resin granules herein have a volume average particle diameter of from about 40 to about 120 nanometers.

The present disclosure also provides an emulsifiable granule comprising at least one resin that is free of organic solvent; an alkyl benzene sulfonate surfactant having an ammonium salt counter ion, wherein the alkyl benzene sulfonate surfactant is substantially free of sodium salt counter ions such that the sodium content of the alkyl benzene sulfonate surfactant is less than about 5,000 parts per million; a neutralization agent; and water; wherein the emulsifiable granule forms a latex emulsion upon contact with water. In embodiments, the emulsifiable granule is for use in a toner composition. In certain embodiments, the self emulsifying granule includes at least one polyester resin.

Resin granules herein can be termed emulsifiable or self-emulsifiable. As used herein, self-emulsifiable means resin granules that emulsify upon addition of water wherein the water can be heated or un-heated (such as room temperature). Any emulsifying technique can be used to emulsify the granule or resin, including, but not limited to, phase inversion emulsification, solvent flashing emulsification, or solvent-free emulsification.

As used herein, “the absence of an organic solvent” includes, in embodiments, that organic solvents are not used to dissolve the resin for emulsification. In some embodiments, solvents may be present in such resins as a consequence of their use in the process of forming the resin. In other embodiments, solvents may be used to emulsify the resin (with the low sodium surfactant), for example, solvents such as methyl ethyl ketone, isopropyl alcohol, dichloromethane, ethyl acetate, and the like, can be used to dissolve the granule and process to make an emulsion.

Resin.

Any suitable or desired resin can be used in the processes herein. In embodiments, the resin can be an amorphous resin, a crystalline resin, or a mixture or combination thereof. In further embodiments, the resin can be a polyester resin, including the resins described in U.S. Pat. No. 6,593,049 and U.S. Pat. No. 6,756,176, which are each hereby incorporated by reference herein in their entireties. Suitable resins can also include a mixture of an amorphous polyester resin and a crystalline polyester resin as described in U.S. Pat. No. 6,830,860, which is hereby incorporated by reference herein in its entirety.

In embodiments, the resin can be a polyester resin formed by reacting a diol with a diacid in the presence of an optional catalyst. For forming a crystalline polyester, suitable organic diols include aliphatic diols having from about 2 to about 36 carbon atoms, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol, and the like, including their structural isomers.

The aliphatic diol can be selected in any suitable or desired amount, in embodiments, from about 40 to about 60 mole percent, or from about 42 to about 55 mole percent, or from about 45 to about 53 mole percent, and, in embodiments, a second diol can be selected in any suitable or desired amount, in embodiments, from about 0 to about 10 mole percent, or from about 1 to about 4 mole percent of the resin.

Examples of organic diacids or diesters including vinyl diacids or vinyl diesters that can be selected for the preparation of the crystalline resins include oxalic acid, succinic acid, glutaric acid, adipic acid, suberic acid, azelaic acid, sebacic acid, fumaric acid, dimethyl fumarate, dimethyl itaconate, cis-1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid, mesaconic acid, a diester or anhydride thereof, and mixtures and combinations thereof.

The organic diacid can be selected in any suitable or desired amount, in embodiments, from about 40 to about 60 mole percent, or from about 42 to about 52 mole percent, or from about 45 to about 50 mole percent, and in embodiments, a second diacid can be selected in any suitable or desired amount, such as from about 0 to about 10 mole percent of the resin.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures and combinations thereof, and the like. Specific crystalline resins can be polyester based, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene-dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), copoly(2,2-dimethylpropane-1,3-diol-decanoate)-copoly(nonylene-decanoate), poly(octylene-adipate).

Examples of polyamides include poly(ethylene-adipamide), poly(propylene-adipamide), poly(butylene-adipamide), poly(pentylene-adipamide), poly(hexylene-adipamide), poly(octylene-adipamide), poly(ethylene-succinimide), and poly(propylene-sebacamide).

Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The crystalline resin can be present in any suitable or desired amount, such as from about 5 to about 90 percent, or from about 10 to about 35 percent by weight, based on the total weight of the toner or self-emulsifying granule components.

The crystalline resin can possess various melting points such as from about 30° C. to about 120° C., or from about 50° C. to about 90° C. The crystalline resin can have a number average molecular weight (Mₙ), as measured by gel permeation chromatography (GPC) of, for example, from about 1,000 to about 50,000, or from about 2,000 to about 25,000, and a weight average molecular weight (M_{w}), of, for example, from about 2,000 to about 100,000, or from about 3,000 to about 80,000, as determined by gel permeation chromatography (GPC) using polystyrene standards. The molecular weight distribution (Mw/Mn) of the crystalline resin may be, for example, from about 2 to about 6, or from about 3 to about 4.

Examples of diacid or diesters selected for the preparation of amorphous polyesters include dicarboxylic acids or diesters such as terephthalic acid, phthalic acid, isophthalic acid, fumaric acid, trimellitic acid, dimethylfumarate, dimethylitaconate, cis-1,4-diacetoxy-2-butene, diethyl fumarate, diethyl maleate, maleic acid, succinic acid, itaconic acid, succinic anhydride, dodecylsuccinic acid, dodecylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and mixtures and combinations thereof. The organic diacid or diester may be present in any suitable or desired amount, for example, in an amount from about 40 to about 60 mole percent of the resin, or from about 42 to about 55 mole percent of the resin, or from about 45 to about 53 mole percent of the resin.

Examples of diols which can be utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene, and mixtures and combinations thereof. The amount of organic diol selected can vary, and may be selected in any suitable or desire amount, for example, in an amount of from about 40 to about 60 mole percent of the resin, or from about 42 to about 55 mole percent of the resin, or from about 45 to about 53 mole percent of the resin.

In embodiments, suitable amorphous resins include polyesters, polyamides, polyimides, polyolefins, polyethylene, polybutylene, polyisobutyrate, ethylene-propylene copolymers, ethylene-vinyl acetate copolymers, polypropylene, and mixtures and combinations thereof, and the like. Examples of amorphous resins which may be utilized include alkali sulfonated-polyester resins, branched alkali sulfonated-polyester resins, alkali sulfonated-polyimide resins, and branched alkali sulfonated-polyimide resins. Alkali sulfonated polyester resins may be useful in embodiments, such as the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfoisophthalate), copoly(propylene-butylene-terephthalate)-copoly(propylene-butylene-5-sulfo-isophthalate), and copoly(propoxylated bisphenol-A-fumarate)-copoly(propoxylated bisphenol A-5-sulfo-isophthalate).

In embodiments, polycondensation catalysts may be used in forming the polyesters. Polycondensation catalysts which may be utilized for either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, and mixtures and combinations thereof. Such catalysts may be utilized in any suitable or desired amount, such as from about 0.01 mole percent to about 5 mole percent based on the starting diacid or diester used to generate the polyester resin.

In embodiments, as noted above, an unsaturated, amorphous polyester resin may be utilized as a latex resin. Examples of such resins include those disclosed in U.S. Pat. No. 6,063,827, the disclosure of which is hereby incorporated by reference herein in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof.

In embodiments, a suitable polyester resin may be a an amorphous polyester such as a poly(propoxylated bisphenol A co-fumarate) resin having the following formula (I):

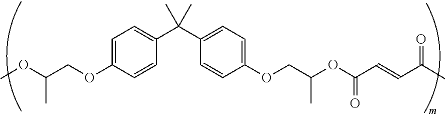

wherein m is an integer, in embodiments of from about 5 to about 1000, or from about 10 to about 500, or from about 15 to about 200.

An example of a linear propoxylated bisphenol A fumarate resin which may be utilized as a latex resin is the resin available under the trade name SPARII from Resana S/A Industrias Quimicas, Sao Paulo, Brazil. Other propoxylated bisphenol A fumarate resins that may be utilized and are commercially available include GTUF and FPESL-2 from Kao Corporation, Japan, and EM181635 from Reichhold, Research Triangle Park, N.C.

Suitable crystalline resins which may be utilized, optionally in combination with an amorphous resin as described above, include those disclosed in U.S. Patent Publication 2006/0222991, the disclosure of which is hereby incorporated by reference herein in its entirety. In embodiments, a suitable crystalline resin may include a resin formed of ethylene glycol and a mixture of dodecanedioic acid and fumaric acid co-monomers of the following formula:

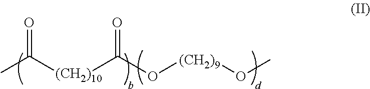

wherein b is an integer, in embodiments, of from about 5 to about 2,000 and d is an integer, in embodiments, of from about 5 to about 2,000.

For example, in embodiments, a poly(propoxylated bisphenol A co-fumarate) resin of formula I as described above may be combined with a crystalline resin of formula II to form a latex emulsion.

Examples of other suitable resins or polymers which may be utilized include those based upon styrenes, acrylates, methacrylates, butadienes, isoprenes, acrylic acids, methacrylic acids, acrylonitriles, and combinations thereof. Exemplary additional resins or polymers include, but are not limited to, poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylonitrile), and poly(styrene-butyl acrylate-acrylonitrile-acrylic acid), and mixtures and combinations thereof. The polymer may be block, random, or alternating copolymers.

The amorphous resin can be present in any suitable or desired amount, for example, in embodiments, in an amount of from about 30 to about 90 percent by weight based on the total weight of the toner or self-emulsifying granule components.

In embodiments, the amorphous resin or combination of amorphous resins may have a glass transition temperature of from about 30° C. to about 80° C., or from about 35° C. to about 70° C. In further embodiments, the combined resins utilized in the latex may have a melt viscosity of from about 10 to about 1,000,000 Pa*S at about 130° C., or from about 20 to about 100,000 Pa*S at about 130° C., or from about 50 to about 100,000 Pa*S at about 130° C.

One, two, or more resins may be used. In embodiments where two or more resins are used, the resins may be present in any suitable or desired ratio (e.g., weight ratio) such as, for instance, about 1% (first resin)/99% (second resin) to about 99% (first resin) 1% (second resin), or from about 10% (first resin)/90% (second resin) to about 90% (first resin)/10% (second resin). Where the resin includes an amorphous resin and a crystalline resin, the weight ratio of the amorphous resin and crystalline resin can be any suitable or desired ratio, in embodiments, from about 99% (amorphous resin):90% (crystalline resin).

In embodiments, the resin may possess acid groups which, in embodiments, may be present at the terminal of the resin. Acid groups which may be present include carboxylic acid groups, and the like. The number of carboxylic acid groups may be controlled by adjusting the materials utilized to form the resin and the reaction conditions.

In embodiments, the resin may be a polyester resin having an acid number from about 2 mg KOH/g of resin to about 200 mg KOH/g of resin, or from about 5 mg KOH/g of resin to about 50 mg KOH/g of resin. The acid containing resin may be dissolved in tetrahydrofuran solution. The acid number may be detected by titration with KOH/methanol solution containing phenolphthalein as the indicator. The acid number may then be calculated based on the equivalent amount of KOH/methanol required to neutralize all of the acid groups on the resin identified as the end point of the titration.

Neutralizing Agent.

Once obtained, the resin may be melt-mixed at an elevated temperature, with a base or neutralizing agent added thereto in any suitable or desired amount. In embodiments, the base may be provided in an amount of from about 0.01 to about 7, or from about 0.05 to about 6, or from about 0.1 to about 5 weight percent, based on the total weight of the resin.

In embodiments, the neutralizing agent may be used to neutralize acid groups in the resins, so a neutralizing agent herein may also be referred to as a “base neutralization agent.” Any suitable or desired base neutralization reagent may be used. In embodiments, suitable base neutralization agents include both inorganic basic agents and organic basic agents. Suitable basic agents include ammonium hydroxide, potassium hydroxide, sodium hydroxide, sodium carbonate, sodium bicarbonate, lithium hydroxide, potassium carbonate, organoamines, such as triethyl amine, and mixtures and combinations thereof. Suitable basic agents may also include monocyclic compounds and polycyclic compounds, having at least one nitrogen atom, such as secondary amines, which include aziridines, azetidines, piperazines, piperidines, pyridines bipyridines, terpyridines, dihydropyridines, morpholines, N-alkylmorpholines, 1,4-diazabicyclo [2.2.2]octanes, 1,8-diazabicycloundecanes, 1,8-diazabicycloundecenes, dimethylated pentylamines, trimethylated pentylamines, pyrimidines, pyrroles, pyrrolidines, pyrrolidinones, indoles, indulines, indanones, benzindazones, imidazoles, benzimidazoles, imidazolines, imidazolines, oxazoles, isoxazoles, oxazolines, oxadiazoles, thiadiazoles, carbazoles, quinolines, isoquinolines, naphthyridines, triazines, triazoles, tetrazoles, pyrazoles, pyrazolines, and mixtures and combinations thereof. In embodiments, the monocyclic and polycyclic compounds may be unsubstituted or substituted at any carbon position on the ring.

In embodiments, the self-emulsifying resin granule formed in accordance with the present disclosure may also include a small quantity of water, in embodiments, deionized water, in any suitable or desired amount, in embodiments in amounts of from about 5% to about 30%, or from about or from about 8% to about 25%, at temperatures that melt or soften the resin, such as from about 70° C. to about 120° C., or from about 75° C. to about 95° C., at least one neutralizing agent.

The neutralizing agent or basic agent may be present in any suitable or desired amount, in embodiments at from about 0.001% to about 50% by weight, or from about 0.01% to about 25% by weight, or from about 0.2% to about 5% by weight, based upon the weight of the resin.

Utilizing the neutralizing agent in combination with a resin possessing acid groups, a neutralization ratio of from about 50% to about 300%, or from about 70% to about 200%, may be achieved, although values outside these ranges may be obtained. In embodiments, the neutralization ratio may be calculated using the following:

Neutralization ratio in percentile is equal to the number of base moieties used divided by the number of resin acid groups present multiplied by 100%.

As noted herein, the basic neutralizing agent may be added to a resin possessing acid groups. The addition of the basic neutralizing agent may thus raise the pH of an emulsion including a resin possessing acid groups from about 5 to about 12, or from about 6 to about 11, although values outside these ranges may be obtained. The neutralization of the acid groups may, in embodiments, enhance formation of the emulsion.

Surfactant.

In embodiments, the process herein may include adding a surfactant, before or during the melt mixing or emulsification process, to the resin, in embodiments, at an elevated temperature. In embodiments, the surfactant may be added prior to melt-mixing the resin at an elevated temperature. In embodiments, the resin emulsion may include one, two, or more surfactants.

In embodiments, the surfactant selected herein is an alkyl benzene sulfonate surfactant that is substantially free of (does not contain) sodium salt counter ions. In specific embodiments, the surfactant herein is an alkyl benzene sulfonate surfactant having an ammonium salt counter ion, wherein the alkyl benzene sulfonate surfactant is substantially free of sodium salt counter ions such that the sodium content of the alkyl benzene sulfonate surfactant is less than about 5,000 parts per million, that is, in embodiments, the sodium content of the alkyl benzene sulfonate surfactant is less than about 5,000 parts sodium per million parts of total surfactant.

Any suitable or desired alkyl benzene sulfonate surfactant that is substantially free of (does not contain) sodium salt counter ions can be used in embodiments herein. In embodiments, the alkyl benzene sulfonate surfactant herein includes a compound of the formula

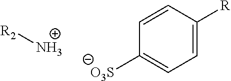

wherein R and R₂ are as described below.

In embodiments, the alkyl benzene sulfonate surfactant includes a compound of the formula

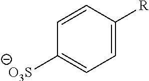

wherein R is hydrogen or an alkyl group. The alkyl portion of the alkyl benzene sulfonate surfactant can comprise any suitable or desired number of carbon atoms. In embodiments, R can comprise an alkyl group having from about 1 to about 100 carbon atoms, or from about 1 to about 75 carbon atoms, or from about 1 to about 50 carbon atoms, or from about 1 to about 25 carbon atoms. In a specific embodiment, R is an alkyl group having 12 carbon atoms.

In some embodiments, the alkyl portion of the alkyl benzene sulfonate surfactant is branched. In other embodiments, the alkyl portion of the alkyl benzene sulfonate surfactant is linear.

In certain embodiments, the alkyl benzene sulfonate surfactant herein includes an ammonium salt counter ion. Any suitable or desired ammonium salt counter ion can be selected in embodiments herein. In embodiments, the ammonium salt counter ion includes a compound of the formula

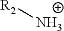

wherein R₂ can comprise hydrogen or an alkyl group, which can be linear or branched, having from about 1 to about 100 carbon atoms, or from about 1 to about 80 carbon atoms, or from about 1 to about 50 carbon atoms, or from about 1 to about 40 carbon atoms. In a specific embodiment, R₂ is an alkyl group having 3 carbon atoms.

Mixtures and combinations of such surfactants can also be selected in embodiments herein.

In a specific embodiment, the surfactant having an ammonia counter ion is a compound of the formula

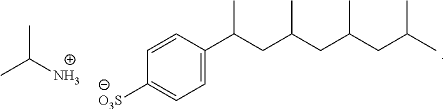

For example, the isopropylamine (branched) alkyl benzene sulfonate surfactant commercially available as Calimulse® PR (Pilot Chemical Company) can be selected.

In another specific embodiment, the surfactant having an ammonia counter ion is a compound of the formula

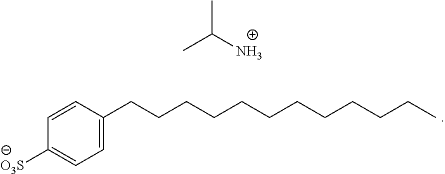

For example, the isopropylamine (linear) alkyl benzene sulfonate surfactant commercially available as Calimulse® PRS (Pilot Chemical Company) can be selected.

The sodium content for selected surfactants is shown in Table 1 below.

TABLE 1

| Surfactant | Structure | Na | S |
|---|---|---|---|
| Tayca ® Power | Sodium dodecylbenzene | 18,080 | 21,220 |
| | sulphonate, Branched alkyl | | |
| Dowfax ® | C12 (Branched) sodium | 46,420 | 47,161 |
| | diphenyloxide disulfonate | | |
| Calimulse ® SLS | Sodium Lauryl Sulfate (C10-C16) | 21,090 | 30,770 |
| Spectrum ® SLS | Sodium Lauryl Sulfate (C12) | 71,230 | 56,570 |
| Calfoam ® | Sodium Lauryl Sulfate (C10-C16) | 16,580 | 28,500 |
| SLS-30 | with 2% Alcohol (C10-C16) | | |
| Calimulse ® PR | Isopropylamine (Branched) | 507 | 77,400 |
| | Alkyl Benzene Sulfonate | | |
| Calimulse ® PRS | Isopropylamine (Linear) Alkyl | 292 | 81,395 |
| | Benzene Sulfonate | | |

As can be seen in Table 1, the sodium content for previously used surfactants ranges from about 16,000 to about 71,000 parts per million. In embodiments herein, the sodium content of the alkyl benzene sulfonate surfactant is less than about 5,000 parts per million, or less than about 1,000 parts per million. In certain embodiments herein, the sodium content of the alkyl benzene sulfonate surfactant is less than about 1,000 parts per million, or less than about 500 parts per million, or less than or equal to about 500 parts per million, or less than about 300 parts per million. The sodium content for the ammonia-based (sodium free) surfactants, such as Calimulse® PR and Calimulse® PRS, is less than or equal to about 500 parts per million or less than or equal to less than about 300 parts per million.

In embodiments, the sodium content of the emulsifiable granules herein is less than about 5,000 parts per million, or less than about 1,000 parts per million, or less than or equal to about 500 parts per million, or less than or equal to about 300 parts per million. In other embodiments, the sodium content of the emulsifiable granules herein is from about 200 to about 525 parts per million. In embodiments, the surfactants herein contain little to no sodium content. In embodiments, the quantity of sodium ions introduced during the emulsification of resins herein is reduced which, in embodiments, reduces or eliminates altogether the need for downstream processing to remove sodium ions.

The emulsifiable granules herein can be selected for toners where reducing the sodium content in the raw material and toner are desired to reduce washing requirements and improve toner charging latitudes. Further, in embodiments, the alkyl benzene sulfonate surfactants selected herein are more efficient and less sensitive to heat and mixing and other processing as compared with previous used surfactants, thus providing improved emulsions with less variation when using the emulsions for preparing, for example, toners or other materials, such as pigment dispersions or wax dispersions. Still further, in embodiments, the alkyl benzene sulfonate surfactants can be selected for use with any resin having an ionic group, such as styrene/acrylate and polyester resins, including bio-based resins, and most conventional polyester resins.

In embodiments, the alkyl benzene sulfonate surfactant herein has a sulfur content of greater than about 60,000 parts per million, that is, has a sulfur content that is greater than about 60,000 parts sulfur per million parts total alkyl benzene sulfonate surfactant. In embodiments, the alkyl benzene sulfonate surfactant herein has a sulfur content of greater than about 60,000 parts per million to about 100,000 parts per million total alkyl benzene sulfonate surfactant.

In embodiments, the sulfur content of the emulsifiable resin granules herein is greater than about 60,000 parts per million, or from greater than about 60,000 parts per million to about 100,000 parts per million.

The surfactant may be used in any suitable or desired amount. In embodiments, the surfactant may be added as a solid or as a highly concentrated solution with a concentration of from about 10% to about 100% (pure surfactant), or from about 50% to about 95%, by weight. In other embodiments, the surfactant may be present in an amount of from about 0.01% to about 30%, or from about 0.1% to about 25%, or from about 1% to about 14%, by weight of the resin. In embodiments, the surfactant herein is more effective and robust at lower loadings than previous surfactants used for emulsifying resins. In certain embodiments, the lower loading of the present surfactant is from above 0 to about 10% by weight of the resin.

In embodiments, the emulsions and dispersions herein can include one or more additional surfactants in addition to the alkyl benzene sulfonate surfactant. These optional additional surfactants can be selected from known surfactants including surfactants containing sodium salt counter-ions. In embodiments, the optional additional surfactants can be selected from those surfactants commercially available under the tradenames Tayca®, Dowfax®, and the like. The optional additional surfactants can be present in any suitable or desired amount, such as from about 0 to about 5 percent, or from about 0 to about 4 percent, or less than about 5 percent, or less than about 4 percent, by weight based on the total weight of the wax dispersion, colorant dispersion, or resin emulsion. In embodiments, the optional additional surfactant is present in an amount of less than about 5 percent by weight based on the total weight of the wax dispersion, or less than about 4 percent by weight based on the total weight of the colorant dispersion.

Process.

As described herein the present process includes, in embodiments, melt mixing a mixture containing a resin with an alkyl benzene sulfonate surfactant having an ammonium salt counter ion, wherein the alkyl benzene sulfonate surfactant is substantially free of sodium salt counter ions, a neutralizing agent, and water, optionally, at an elevated temperature, wherein an organic solvent is not utilized in the process, to form self-emulsifying resin granules. More than one resin can be utilized to form the granules. As noted above, the resin may be an amorphous resin, a crystalline resin, or a mixture or combination thereof. In embodiments, the resin may be an amorphous resin and the elevated temperature may be a temperature above the glass transition temperature of the resin. In other embodiments, the resin may be a crystalline resin and the elevated temperature may be a temperature above the melting point of the resin. In further embodiments, the resin may be a mixture of amorphous and crystalline resins and the temperature may be above the glass transition temperature of the mixture.

Thus, in embodiments, the process of making the polyester resin granules to be emulsified includes melt mixing the resin for a short period of time with a highly concentrated or solid neutralizing agent, a surfactant having an ammonia counter ion, wherein the surfactant is free of sodium salt counter ions, and, optionally, a small quantity of water, at temperatures that melt or soften the resin.

In embodiments, the surfactant may be added to the one or more ingredients of the resin composition before, during, or after melt-mixing. In embodiments, the surfactant may be added before, during, or after the addition of the neutralizing agent. In embodiments, the surfactant may be added prior to the addition of the neutralizing agent.

In the above-mentioned heating, the elevated temperature may be any suitable or desired temperature, in embodiments, from about 30° C. to about 300° C., or from about 50° C. to about 200° C., or from about 70° C. to about 150° C. The heating need not be held at a constant temperature, but may be varied. For example, the heating may be slowly or incrementally increased during heating until a desired temperature is achieved.

Melt mixing may be conducted in any suitable or desired device, such as in an extruder, for example, a twin screw extruder, a Haake mixer, a batch reactor, or any other device capable of intimately mixing viscous materials to create near homogenous mixtures.

Prior to addition, the neutralizing agent may be at any suitable temperature, including room temperature, typically from about 20° C. to about 25° C., or an elevated temperature, for example, the elevated temperatures mentioned above.

In embodiments, the resin may be added to the mixer with the surfactant and the neutralizing agent and mixed for any suitable or desired amount of time, such as a period of about 30 seconds to about 40 minutes, or about 1 minute to about 25 minutes, or from about 2 minutes to about 15 minutes.

The self-emulsifying material exiting the melt mixer may then be cooled to room temperature and forms a solid material that may be easily crushed, cut or pelletized into granules. In embodiments, the solid material may be pelletized into granules having a volume average diameter (or volume average particle diameter) as determined, for example, by a Brookhaven nanosize particle analyzer, of from about 30 nanometers to about 100 micrometers, or from about 50 nanometers to about 100 micrometers, or from about 100 nanometers to about 50 micrometers, or from about 500 nanometers to about 25 micrometers, although sizes outside of the these ranges may be obtained. In a specific embodiment, the granules herein have a volume average particle diameter of from about 40 to about 120 nanometers.

The self-emulsifying granules may be shipped and stored for prolonged periods of time without affecting the material properties of the resin. In embodiments, the granules may be stored for periods of from about 1 day to about 50 days, or from about 2 days to about 45 days, although time periods outside of these ranges may be obtained.

The self-emulsifiable granules of the present disclosure offer many advantages over the prior art, including, but not limited to, low coarse content, low coarse content meaning, in embodiments, particles less than about 25 microns in size, tight particle size distributions and particle sizes appropriate for emulsion aggregation toner manufacturing, no filtration to eliminate coarse particles. Specifically, the present disclosure provides a process for reducing the sodium content in the final toner product without having to undergo extensive washing to remove sodium content.

As noted hereinabove, the surfactant of the present disclosure may also be utilized to produce other desired materials, such as pigment dispersions and wax dispersions and resin emulsions prepared by any suitable or desired emulsification technique.

Emulsion Formation.

When convenient or desired, the granules of the present disclosure may be added to water to form a latex emulsion. Water may be added in any suitable or desired amount, in embodiments in amounts of from about 50% to about 10,000% of the granule mass, or from about 150% to about 10,000% of the granule mass. While higher water temperatures accelerate the dissolution process, latexes can be formed at temperatures as low as room temperature. In embodiments, water temperatures may be from about 40° C. to about 110° C., or from about 50° C. to about 100° C., although temperatures outside these ranges may be used.

Contact between the water and granules may be achieved in any suitable manner, such as in a vessel or continuous conduit, in a packed bed, or dilute regime. In a batch process, the granules may be added to a hot water bath with low agitation and left to form the latex. In other embodiments, the granules may be held by a sieving device and water may flow through a filter cake of the granules or, alternatively, over a bed of granules, until they dissolve into a latex form. In embodiment, the process herein can comprise contacting a resin with an alkyl benzene sulfonate surfactant having an ammonium salt counter ion, wherein the alkyl benzene sulfonate surfactant is substantially free of sodium salt counter ions, a neutralizing agent, and water, in the absence of an organic solvent to form a mixture; melt mixing the mixture; forming emulsifiable granules of the melt mixed mixture, wherein, in embodiments, the emulsifiable granules have a diameter of from about 30 nanometers to about 100 micrometers, and further adding water to the emulsifiable granules to provide a latex emulsion containing latex particles; and optionally, continuously recovering the latex particles.

The particle size of the latex emulsion formed can be controlled by the concentration ratio of surfactant and neutralizing agent to polyester resin. The solids concentration of the latex may be controlled by the ratio of the granular material to the water.

In accordance with the present disclosure, it has been found that the processes herein may produce emulsified resin particles that retain the same molecular weight properties of the starting resin, in embodiments, bulk or pre-made resin utilized in forming the emulsion.

The emulsified resin particles in the aqueous medium may have a size of from about 1,500 nanometers or less, such as from about 10 to about 1,200 nanometers, or from about 30 to about 1,000 nanometers, such as can be determined by a particle size analyzer, such as a Microtrac Inc. Nanotrac particle size analyzer.

Following emulsification, additional surfactant, water, and/or aqueous alkaline solution may optionally be added to dilute the emulsion, although this is not required. Following emulsification, the emulsion may be cooled to room temperature, for example from about 20° C. to about 25° C.

Toner.

Once the self-emulsifying resin granules have been contacted with water to form an emulsion, the resulting latex emulsion may then be utilized to form a toner by any method within the purview of those skilled in the art. The latex emulsion may be contacted with a colorant, optionally in the form of a colorant dispersion, and other additives to form a toner by a suitable process, in embodiments, an emulsion aggregation and coalescence process.

In embodiments, the optional additional ingredients of a toner composition including colorant, wax, and other additives may be added before, during or after the melt mixing the resin to form the self-emulsifying granules. The additional ingredients may be added before, during, or after the formation of the latex emulsion, wherein the self-emulsifying granule is contacted with water. In further embodiments, the colorant may be added before the addition of the surfactant.

In other embodiments, toner herein can be formed by a process comprising homogenizing a resin emulsion with an alkyl benzene sulfonate surfactant having an ammonium salt counter ion, wherein the alkyl benzene sulfonate surfactant is substantially free of sodium salt counter ions such that the sodium content of the alkyl benzene sulfonate surfactant is less than about 5,000 parts per million, a colorant, and an optional wax, with a coagulant to form a homogenized toner slurry comprising pre-aggregated particles at room temperature; heating the slurry to form aggregated toner particles; freezing the toner slurry once at the desired aggregated particle size; and further heating the aggregated particles in the slurry to coalesce the aggregated particles into toner particles.

Heating to form aggregated toner particles may be to any suitable or desired temperature for any suitable or desired time. In embodiments heating to form aggregated toner particles may be to a temperature below the Tg of the latex, in embodiments to from about 30° C. to about 70° C. or to about 40° C. to about 65° C., for a period of time of from about 0.2 hour to about 6 hours, from about 0.3 hour to about 5 hours, in embodiments, resulting in toner aggregates of from about 3 microns to about 15 microns in volume average diameter, in embodiments of from about 4 microns to about 8 microns in volume average diameter, although not limited.

Freezing the toner slurry to stop particle growth once the desired aggregated particle size is achieved can be by any suitable or desired method. In embodiments, the mixture is cooled in a cooling or freezing step wherein cooling may be at a temperature of from about 20° C. to about 40° C. or from about 22° C. to about 30° C. over a period of from about 1 hour to about 8 hours or from about 1.5 hours to about 5 hours.

In embodiments, cooling a coalesced toner slurry includes quenching by adding a cooling medium such as, for example, ice, dry ice and the like, to effect rapid cooling to a temperature of from about 20° C. to about 40° C. or from about 22° C. to about 30° C. Quenching may be feasible for small quantities of toner, such as, for example, less than about 2 liters, in embodiments from about 0.1 liters to about 1.5 liters. For larger scale processes, such as for example greater than about 10 liters in size, rapid cooling of the toner mixture may not be feasible or practical, neither by the introduction of a cooling medium into the toner mixture, nor by the use of jacketed reactor cooling.

Coalescing the aggregated particles into toner particles can be by any suitable or desired method. In embodiments, coalescing comprises further heating the aggregated particles in the slurry to coalesce the aggregated particles into toner particles. In embodiments, the aggregate suspension may be heated to a temperature at or above the Tg of the latex. Where the particles have a core-shell configuration, heating may be above the Tg of the first latex used to form the core and the Tg of the second latex used to form the shell, to fuse the shell latex with the core latex. In embodiments, the aggregate suspension may be heated to a temperature of from about 80° C. to about 120° C. or from about 85° C. to about 98° C., for a period of time from about 1 hour to about 6 hours or from about 2 hours to about 4 hours.

The toner slurry may then be washed. In embodiments, washing may be carried out at a pH of from about 7 to about 12 or from about 9 to about 11 and the washing may be at a temperature of from about 30° C. to about 70° C. or from about 40° C. to about 67° C. The washing may include filtering and reslurrying a filter cake including toner particles in deionized water. The filter cake may be washed one or more times by deionized water, or washed by a single deionized water wash at a pH of about 4 wherein the pH of the slurry is adjusted with an acid, and followed optionally by one or more deionized water washes.

In embodiments, drying may be carried out at a temperature of from about 35° C. to about 75° C. or from about 45° C. to about 60° C. The drying may be continued until the moisture level of the particles is below a set target of about 1% by weight, in embodiments of less than about 0.7% by weight.

Colorants.

As the colorant to be added, various known suitable colorants, such as dyes, pigments, mixtures of dyes, mixtures of pigments, mixtures of dyes and pigments, and the like, may be included in the toner or colorant dispersions herein. The colorant may be included in any suitable or desired amount, in embodiments, the colorant may be included in the toner in an amount of from about 0.1 to about 35 percent by weight of the toner, or from about 1 to about 15 weight percent of the toner, or from about 3 to about 10 percent by weight of the toner.

As examples of suitable colorants, mention may be made of carbon black such as REGAL 330® (Cabot), Carbon Black 5250 and 5750 (Columbian Chemicals), Sunsperse® Carbon Black LHD 9303 (Sun Chemicals); magnetites, such as Mobay magnetites MO8029™, MO8060™; Columbian magnetites; MAPICO BLACKS® and surface treated magnetites; Pfizer magnetites CB4799™, CB5300™, CB5600™, MCX6369™; Bayer magnetites, BAYFERROX8600™, 8610™; Northern Pigments magnetites, NP604™, NP608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE® 6000, FLEXIVERSE® and AQUATONE® water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC1026™, E.D. TOLUIDINE RED™ and BON RED C™ available from Dominion Color Corporation, Ltd., Toronto, Ontario, NOVAPERM® YELLOW FGL™, HOSTAPERM® PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI-60710, CI Dispersed Red 15, diazo dye identified in the Color Index as CI-26050, CI Solvent Red 19, and the like. Illustrative examples of cyans include copper tetra(octadecyl sulfonamido) phthalocyanine, x-copper phthalocyanine pigment listed in the Color Index as CI-74160, CI Pigment Blue, Pigment Blue 15:3, and Anthrathrene Blue, identified in the Color Index as CI-69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl® Black A-SF (Miles, Bayer) and Sunsperse® Carbon Black LHD 9303 (Sun Chemicals), and colored dyes such as Neopen® Blue (BASF), Sudan Blue OS (BASF), PV Fast Blue B2G01 (American Hoechst), Sunsperse® Blue BHD 6000 (Sun Chemicals), IrgaliteC) Blue BCA (Ciba-Geigy), Paliogen® Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen® Orange 3040 (BASF), Ortho® Orange OR2673 (Paul Uhlich), Paliogen® Yellow 152, 1560 (BASF), Lithol® Fast Yellow 0991K (BASF), Paliotol® Yellow 1840 (BASF), Neopen® Yellow (BASF), Novoperm® Yellow FG 1 (Hoechst), Permanent Yellow YE 0305 (Paul Uhlich), Lumogen® Yellow D0790 (BASF), Sunsperse® Yellow YHD 6001 (Sun Chemicals), Suco-Gelb® L1250 (BASF), Suco-Yellow® D1355 (BASF), Hostaperm® Pink E (American Hoechst), Fanal® Pink D4830 (BASF), Cinquasia® Magenta (DuPont), Lithol® Scarlet D3700 (BASF), Toluidine Red (Aldrich), Scarlet for Thermoplast NSD PS PA (Ugine Kuhlmann of Canada), E.D. Toluidine Red (Aldrich), Lithol® Rubine Toner (Paul Uhlich), Lithol® Scarlet 4440 (BASF), Bon Red C (Dominion Color Company), Royal® Brilliant Red RD-8192 (Paul Uhlich), Oracet® Pink RF (Ciba-Geigy), Paliogen® Red 3871K (BASF), Paliogen® Red 3340 (BASF), Lithol® Fast Scarlet L4300 (BASF), combinations of the foregoing, and the like.

The colorant may be in the form of a colorant dispersion wherein the alkyl benzene sulfonate surfactant is used to disperse the colorant and form the colorant dispersion and wherein, optionally, one or more additional components are added to the colorant dispersion as suitable or desired. The colorant dispersion thus prepared can be used to prepare a toner in any suitable or desired toner process.

In a specific embodiment, the toner process includes a colorant comprising a colorant dispersion prepared by contacting an alkyl benzene sulfonate surfactant having an ammonium salt counter ion with a colorant comprising a pigment, a dye, or a combination thereof, wherein the alkyl benzene sulfonate surfactant is substantially free of sodium salt counter ions such that the sodium content of the alkyl benzene sulfonate surfactant is less than about 5,000 parts per million, and using the alkyl benzene sulfonate surfactant to disperse the colorant and form a colorant dispersion; and optionally, providing an additional surfactant comprising a surfactant containing a sodium salt counter-ion wherein the additional surfactant is provided in an amount of less than about 4 percent by weight based on the total weight of the colorant dispersion.

Wax.

Optionally, a wax may also be combined with the resin and optional colorant in forming toner particles. The wax may be provided in a dispersion, which may include a single type of wax or a mixture of two or more different waxes. A single wax may be added to the toner formulations, for example, to improve particular toner properties, such as toner particle shape, presence, and amount of wax on the toner particle surface, charging and/or fusing characteristics, gloss, stripping, offset properties, and the like. Alternatively, a combination of waxes can be added to provide multiple properties to the toner composition.

The wax may be included in any suitable or desired amount. When included, the wax may be present in an amount of, for example, from about 1 weight percent to about 25 weight percent of the toner particles, or from about 5 weight percent to about 20 weight percent of the toner particles.

When a wax dispersion is used, the wax dispersion may include any of the various waxes conventionally used in emulsion aggregation toner compositions. Waxes that may be selected include waxes having, for example, an average molecular weight of from about 500 to about 20,000, or from about 1,000 to about 10,000. Waxes that may be used include, for example, polyolefins such as polyethylene, polypropylene, and polybutene waxes such as commercially available from Allied Chemical and Petrolite Corporation, for example POLYWAX™ polyethylene waxes from Baker Petrolite, wax emulsions available from Michaelman, Inc. and the Daniels Products Company, EPOLENE N-15™ commercially available from Eastman Chemical Products, Inc., and VISCOL 550P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents. In embodiments, the waxes may be crystalline or non-crystalline.

In certain embodiments, the alkyl benzene sulfonate surfactant is used to disperse a wax and the wax is selected from the group consisting of polyolefins, carnauba wax, rice wax, candelilla wax, sumacs wax, jojoba oil, beeswax, montan wax, ozokerite, ceresin, paraffin wax, microcrystalline wax, Fischer-Tropsch wax, stearyl stearate, behenyl behenate, butyl stearate, propyl oleate, glyceride monostearate, glyceride distearate, pentaerythritol tetra behenate, diethyleneglycol monostearate, dipropyleneglycol distearate, diglyceryl distearate, triglyceryl tetrastearate, sorbitan monostearate, cholesteryl stearate, and mixtures and combinations thereof.

In embodiments, the wax may be incorporated into the toner in the form of one or more aqueous emulsions or dispersions of solid wax in water, where the solid wax particle size may be in the range of from about 100 to about 300 nanometers.

In embodiments, the wax may be in the form of a wax dispersion wherein the alkyl benzene sulfonate surfactant is used to disperse the wax and form the wax dispersion and wherein, optionally, one or more additional components are added to the wax dispersion as suitable or desired. The wax dispersion thus prepared can be used to prepare a toner in any suitable or desired toner process.

In a specific embodiment, the toner process includes a wax comprising a wax dispersion prepared by contacting an alkyl benzene sulfonate surfactant having an ammonium salt counter ion with a wax, wherein the alkyl benzene sulfonate surfactant is substantially free of sodium salt counter ions such that the sodium content of the alkyl benzene sulfonate surfactant is less than about 5,000 parts per million, and water, and using the alkyl benzene sulfonate surfactant to disperse the wax and form the wax dispersion; and optionally, providing an additional surfactant comprising a surfactant containing a sodium salt counter-ion wherein the additional surfactant is provided in an amount of less than about 5 percent by weight based on the total weight of the wax dispersion.

Coagulants.

Optionally, a coagulant may also be combined with the resin, a colorant, and a wax in forming toner particles. Such coagulants may be incorporated into the toner particles during particle aggregation. The coagulant may be present in the toner particles in any suitable or desired amount, such as, exclusive of external additives and on a dry weight basis, in an amount of from about 0 to about 5 weight percent of the toner particles, or from about 0.01 to about 3 weight percent of the toner particles.

Coagulants that may be used include ionic coagulants, such as cationic coagulants. Inorganic cationic coagulants include metal salts, for example, aluminum sulfate, magnesium sulfate, zinc sulfate, potassium aluminum sulfate, calcium acetate, calcium chloride, calcium nitrate, zinc acetate, zinc nitrate, aluminum chloride, and the like.

Examples of organic cationic coagulants include dialkyl benzenealkyl ammonium chloride, lauryl trimethyl ammonium chloride, alkylbenzyl methyl ammonium chloride, alkylbenzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, and mixtures and combinations thereof.

Other suitable coagulants include monovalent metal coagulants, divalent metal coagulants, polyion coagulants, and the like. As used herein, “polyion coagulant” refers to a coagulant that is a salt or oxide, such as a metal salt or metal oxide, formed from a metal species having a valence of at least 3, and desirably at least 4 or 5. Suitable such coagulants include coagulants based on aluminum salts, such as aluminum sulphate and aluminum chlorides, polyaluminum halides such as polyaluminum fluoride and polyaluminum chloride (PAC), polyaluminum silicates such as polyaluminum sulfosilicate (PASS), polyaluminum hydroxide, polyaluminum phosphate, and the like.

Other suitable coagulants include tetraalkyl titinates, dialkyltin oxide, tetraalkyltin oxide hydroxide, dialkyltin oxide hydroxide, aluminum alkoxides, alkylzinc, dialkyl zinc, zinc oxides, stannous oxide, dibutyltin oxide, dibutyltin oxide hydroxide, tetraalkyltin, and the like. Where the coagulant is a polyion coagulant, the coagulant may have any desired number of polyion atoms present. For example, suitable polyaluminum compounds have from about 2 to about 13, or from about 3 to about 8, aluminum ions present in the compound.

Additives.

In embodiments, the toner particles may further contain optional additives as desired or required. For example, the toner may include positive or negative charge control agents, such as in an amount of from about 0.1 to about 10%, or from about 1 to about 3% by weight of the toner. Examples of suitable charge control agents include quaternary ammonium compounds inclusive of alkyl pyridinium halides, bisulfates, alkyl pyridinium compounds, including those disclosed in U.S. Pat. No. 4,298,672, which is hereby incorporated by reference herein in its entirety, organic sulfate and sulfonate compositions, including those discloses in U.S. Pat. No. 4,338,390, which is hereby incorporated by reference herein in its entirety, cetyl pyridinium tetrafluoroborates, distearyl dimethyl ammonium methyl sulfate, aluminum salts such as CONTRON E84™ or E88™ (Orient Chemical Industries, Ltd.), and mixtures and combinations thereof.

There can also be blended with the toner particles external additive particles including flow aid additives, which additives may be present on the surface of the toner particles. Examples of these additives include metal oxides such as titanium oxide, silicon oxide, aluminum oxide, cerium oxide, tin oxide, mixtures thereof, and the like; colloidal and amorphous silicas, such as AEROSIL®, metal salts and metal salts of fatty acids inclusive of zinc stearate, calcium stearate, or long chain alcohols such as UNILIN® 700, and mixtures and combinations thereof.

Silica may be applied to the toner surface for toner flow, tribo enhancement, admix control, improved development and transfer stability, and higher toner blocking temperature. TiO₂ may be applied for improved relative humidity (RH) stability, tribo control, and improved development and transfer stability. Zinc stearate, calcium stearate and/or magnesium stearate may optionally also be used as an external additive for providing lubricating properties, developer conductivity tribo enhancement, enabling higher toner charge and charge stability by increasing the number of contacts between toner an carrier particles. In embodiments, a commercially available zinc stearate known as Zinc Stearate L, available from Ferro Corporation, may be used. The external surface additives may be used with or without a coating.

Each of these external additives may be present in any suitable or desired amount, such as from about 0.1 percent by weight to about 5 percent by weight of the toner, or from about 0.25 percent by weight to about 3 percent by weight of the toner.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

### Example 1

Control. Solvent-free emulsifiable granules with Dowfax®. A Haake melt mixer equipped with counter-rotating rotors was preheated to 95° C. and then set to a rotor speed of 60 rpm (revolutions per minute). An amorphous resin (poly(co-propoxylated bisphenol co-ethoxylated bisphenol co-terephthalate), available from KAO Corporation), 39.37 grams) mixed with sodium hydroxide (NaOH, 0.82 gram) was slowly added to the cavity of the mixer; followed by the surfactant (Dowfax® 2A1, 10.06 grams, 47.5% active) where the rpm was then increased to 100 rpm and held mixing for 15 minutes. Then a small amount of deionized water (12.54 grams) was slowly added and left mixing for another 20 minutes. The total run time was 73 minutes. The product was collected from the Haake mixer cavity and solidified upon cooling. This solid material (about 1 gram) was put in a 4 drum glass vial with 23 grams of deionized water and placed in a water bath set at 90° C. for 1 hour.

It was determined that no emulsion was made due to the excessive mixing and long run times. However, even with this procedure (as seen in Example 2) Calimulse® PR (isopropylamine branched alkyl benzene sulfonate, available from Pilot Chemical Company) emulsified, showing the robustness of this surfactant with heat, time and mixing.

### Example 2

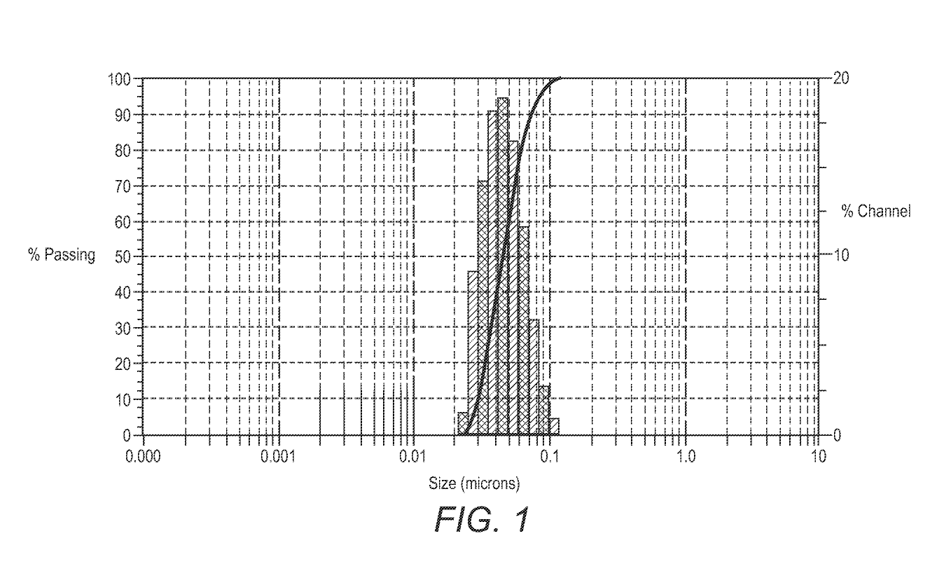

Solvent-free emulsifiable granules with Calimulse® PR. A Haake melt mixer equipped with counter-rotating rotors was preheated to 95° C. and then set to a rotor speed of 60 rpm. An amorphous resin (poly(co-propoxylated bisphenol co-ethoxylated bisphenol co-terephthalate), available from KAO Corporation), 39.37 grams) mixed with sodium hydroxide (NaOH, 0.82 grams) was slowly added to the cavity of the mixer; followed by the surfactant (Calimulse® PR, 5.14 grams, 93% active), where the rpm was then increased to 100 rpm and held mixing for 15 minutes. Then a small amount of deionized water (12.54 grams) was slowly added and left mixing for another 20 minutes. Total run time was 84 minutes. The product was collected from the Haake mixer cavity and solidified upon cooling. This solid material (about 1 gram) was put in a 4 drum glass vial with 23 grams of deionized water and placed in a water bath set at 90° C. for 1 hour. Particle sizes of the resulting resin were obtained with a Nanotrac® Particle Size analyzer (Microtrac Inc.), with particle size distribution as shown in FIG. 1. Particle size and standard deviation as measured by the Nanotrac® were 46 nanometers and 0.0165, respectively.

### Example 3

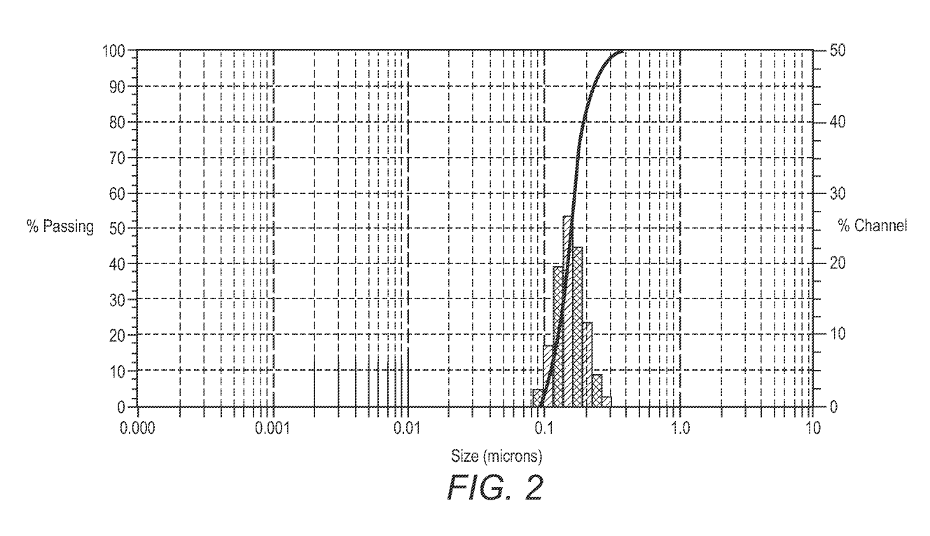

Control. Solvent-free emulsifiable granules with Dowfax® 2A1. With a new procedure in place, the surfactant in Example 1 was re-run. A Haake melt mixer equipped with counter-rotating rotors was preheated to 95° C. and then set to a rotor speed of 60 rpm. An amorphous (poly(co-propoxylated bisphenol co-ethoxylated bisphenol co-terephthalate), available from KAO Corporation), 39.37 grams) mixed with sodium hydroxide (NaOH, 0.39 grams) was added to the cavity of the mixer. The rpm was then increased to 100 rpm and the surfactant (Dowfax® 2A1, 4.97 grams, 47.5% active) was then added, followed by a small amount of deionized water (12.54 grams). Total run time was 27 minutes. The product was collected from the Haake mixer cavity and solidified upon cooling. This solid material (about 1 gram) was put in a 4 drum glass vial with 23 grams of deionized water and placed in a water bath set at 90° C. for 1 hour. Particle sizes of the resulting resin were obtained with a Nanotrac® Particle Size analyzer (Microtrac Inc.), with particle size distribution as shown in FIG. 2. Particle size and standard deviation as measured by the Nanotrac® were 163 nanometers and 0.0416, respectively.

### Example 4

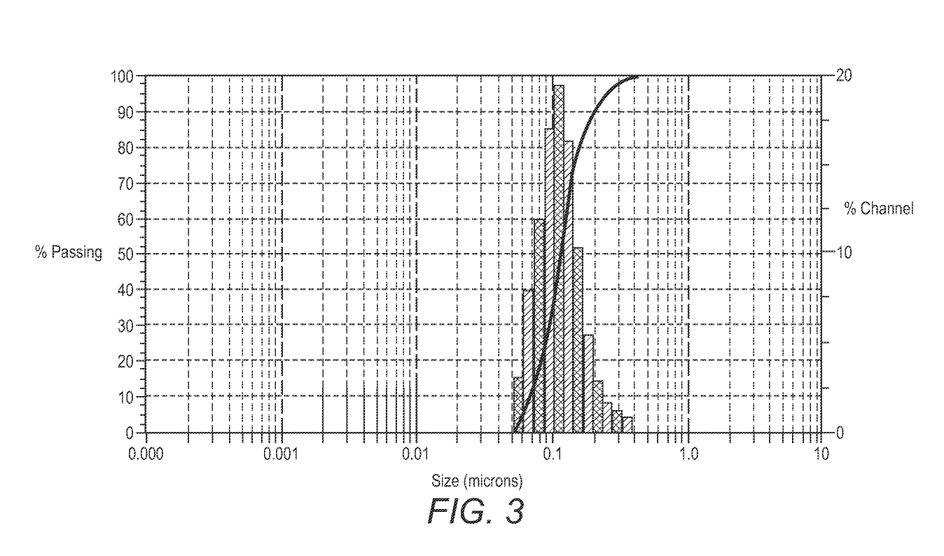

Solvent-free emulsifiable granules with Calimulse® PRS. A Haake melt mixer equipped with counter-rotating rotors was preheated to 95° C. and then set to a rotor speed of 60 rpm. An amorphous resin (poly(co-propoxylated bisphenol co-ethoxylated bisphenol co-terephthalate), available from KAO Corporation), 39.37 grams) mixed with sodium hydroxide (NaOH, 0.39 grams) was added to the cavity of the mixer. The rpm was then increased to 100 rpm and the surfactant (Calimulse® PRS, isopropylamine linear alkyl benzene sulfonate, 5.14 grams, 93% active) was then added; followed by a small amount of deionized water (12.54 grams). Total run time was 24 minutes. The product was collected from the Haake mixer cavity and solidified upon cooling. This solid material (about 1 gram) was put in a 4 drum glass vial with 23 grams of deionized water and placed in a water bath set at 90° C. for 1 hour. Particle sizes of the resulting resin were obtained with a Nanotrac® Particle Size analyzer (Microtrac Inc.), with particle size distribution as shown in FIG. 3. Particle size and standard deviation as measured by the Nanotrac® were 111 nanometers and 0.0415, respectively.

### Example 5

A cyan polyester emulsion aggregation toner consists of about 150 grams dry theoretical toner at a 2 liter bench scale. About 23% by weight of a high molecular weight amorphous resin (poly(co-propoxylated bisphenol co-ethoxylated bisphenol co-terephthalate), about 23% by weight of the emulsion prepared in Example 2, and about 30% by weight of a crystalline resin emulsion (poly(1,9-nonane-1,12 dodecanoate) is combined with 2 weight % based on resin solids of DOWFAX™ 2A1, an alkyldiphenyloxide disulfonate available commercially from The Dow Chemical Company, about 5.5% by weight of a cyan pigment (Pigment Blue 15:3) in a dispersion, and about 9% of a polyethylene wax (available from IGI) in a dispersion. The components are mixed and then pH adjusted to about 4.2 using about 0.3M nitric acid.

The slurry is then homogenized for about 10 minutes at from about 3,000 revolutions per minute (rpm) to about 4,000 rpm while adding about 0.5 parts per million (ppm) of aluminum sulfate as a coagulant. The toner slurry is then transferred to the 2 liter Buchi reactor and heated to begin aggregation. The toner slurry would then be aggregated at a temperature of around 43° C. At around 4.8 microns in size, a shell including the 14% by weight of the high molecular weight amorphous resin, 14% by weight of the emulsion prepared in Example 2 is added to the toner slurry to achieve the final targeted particle size of about 5.8 microns. The pH of the slurry is adjusted to about 7.5 using sodium hydroxide (NaOH) and VERSENE-100 (chelating agent available from the Dow Chemical Company) to freeze, i.e. stop, the aggregation step.

The process proceeds with the reactor temperature (Tr) increasing to achieve 85° C. while maintaining a pH≧about 7.8 until Tr was about 80° C. Once the Tr reaches 85° C., the pH of the toner slurry is reduced with the addition of diluted nitric acid and is held until the circularity reached ≧about 0.960.

### Example 6

A cyan polyester emulsion aggregation toner consists of about 150 grams dry theoretical toner at a 2 liter bench scale. About 23% by weight of a high molecular weight amorphous resin (poly(co-propoxylated bisphenol co-ethoxylated bisphenol co-terephthalate) and about 23% by weight of the emulsion prepared in Example 4 and about 30% by weight of a crystalline resin emulsion [poly(1,9-nonane-1,12 dodecanoate) is combined with 2 weight % based on resin solids of DOWFAX™ 2A1, an alkyldiphenyloxide disulfonate available commercially from The Dow Chemical Company, about 5.5% by weight of a cyan pigment (Pigment Blue 15:3) in a dispersion, and about 9% of a polyethylene wax (from IGI) in a dispersion. The components are mixed and then pH adjusted to about 4.2 using about 0.3M nitric acid.

The slurry is then homogenized for about 10 minutes at from about 3,000 revolutions per minute (rpm) to about 4,000 rpm while adding about 0.5 parts per million (ppm) of aluminum sulfate as a coagulant. The toner slurry is then transferred to the 2 liter Buchi reactor and heated to begin aggregation. The toner slurry would then be aggregated at a temperature of around 43° C. At around 4.8 microns in size, a shell including the 14% by weight of the high molecular weight amorphous resin, 14% by weight of the emulsion prepared in Example 4 is added to the toner slurry to achieve the final targeted particle size of about 5.8 microns. The pH of the slurry is adjusted to about 7.5 using sodium hydroxide (NaOH) and VERSENE-100 (chelating agent available from the Dow Chemical Company) to freeze, i.e. stop, the aggregation step.

The process proceeds with the reactor temperature (Tr) increasing to achieve 85° C. while maintaining a pH≧about 7.8 until Tr was about 80° C. Once the Tr reaches 85° C., the pH of the toner slurry is reduced with the addition of diluted nitric acid and is held until the circularity reached ≧about 0.960.

### Example 7

A pigment dispersion consisting of 20 to 40 weight % raw pigment, Pigment Blue15:3 from Sun Chemicals, with about 7 to 11 weight % of the alkyl benzene sulfonate surfactant having an ammonium salt counter ion and deionized water is mixed. Once wetted, the mixture is sheared using known dispersing tools such as rotor-stator homogenizer, piston homogenizer, ball mill etc., until desired particle size is achieved, such as from about 100 to 500 nanometers.

### Example 8

A wax dispersion consisting of 20 to 40 weight % polyethylene wax (available from IGI) with about 7 to 11 weight % of the alkyl benzene sulfonate surfactant having an ammonium salt counter ion and deionized water is mixed. Once wetted, the mixture is heated to near or above the wax glass transition temperature and sheared using known dispersing tools such as rotor-stator homogenizer, piston homogenizer, ball mill, etc., until desired particle size is achieved, such as from about 100 to 500 nanometers.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A process comprising:
contacting an alkyl benzene sulfonate surfactant having an ammonium salt counter ion with a component to be emulsified or dispersed, wherein the alkyl benzene sulfonate surfactant is substantially free of sodium salt counter ions such that the sodium content of the alkyl benzene sulfonate surfactant is less than about 5,000 parts per million, and water to form a mixture;
using the alkyl benzene sulfonate surfactant to emulsify the component and form an emulsion; or
using the alkyl benzene sulfonate surfactant to disperse the component and form a dispersion.

2. The process of claim 1, wherein the alkyl benzene sulfonate surfactant is a compound of the formula 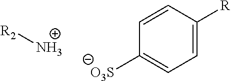
wherein R is hydrogen or an alkyl group having from about 1 to about 100 carbon atoms; and
wherein R₂ is hydrogen or an alkyl group having from about 1 to about 100 carbon atoms.

3. The process of claim 1, wherein the alkyl benzene sulfonate surfactant is a compound of the formula

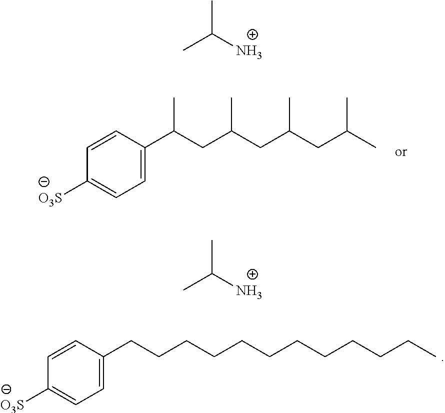

4. The process of claim 1, wherein the sodium content of the alkyl benzene sulfonate surfactant is less than about 1,000 parts per million.

5. The process of claim 1, wherein the sulfur content of the alkyl benzene sulfonate surfactant is from greater than about 60,000 to about 100,000 parts per million.

6. The process of claim 1, wherein the component is a resin and the alkyl benzene sulfonate surfactant is used to emulsify the resin and form a resin emulsion; and wherein the process includes optionally, adding one or more additional components to the resin emulsion.

7. The process of claim 1, wherein the alkyl benzene sulfonate surfactant is used to emulsify a resin and wherein the alkyl benzene sulfonate surfactant is present in an amount of from about 0.01% to about 30% by weight, based on the total weight of the resin.

8. The process of claim 1, wherein the alkyl benzene sulfonate surfactant is used to emulsify a resin and wherein the resin is selected from the group consisting of amorphous resins, crystalline resins, and mixtures and combinations thereof.

9. The process of claim 1, wherein the component is a wax and the alkyl benzene sulfonate surfactant is used to disperse the wax and form a wax dispersion; and wherein the process includes optionally, adding one or more additional components to the wax dispersion.

10. The process of claim 1, wherein the component is a colorant and the alkyl benzene sulfonate surfactant is used to disperse the colorant and form a colorant dispersion; and wherein the process includes optionally, adding one or more additional components to the colorant dispersion.

11. The process of claim 1, wherein the alkyl benzene sulfonate surfactant is used to disperse a wax and wherein the wax is selected from the group consisting of polyolefins, carnauba wax, rice wax, candelilla wax, sumacs wax, jojoba oil, beeswax, montan wax, ozokerite, ceresin, paraffin wax, microcrystalline wax, Fischer-Tropsch wax, stearyl stearate, behenyl behenate, butyl stearate, propyl oleate, glyceride monostearate, glyceride distearate, pentaerythritol tetra behenate, diethyleneglycol monostearate, dipropyleneglycol distearate, diglyceryl distearate, triglyceryl tetrastearate, sorbitan monostearate, cholesteryl stearate, and mixtures and combinations thereof.

12. The process of claim 1, wherein the alkyl benzene sulfonate surfactant is used to disperse a colorant and wherein the colorant is selected from the group consisting of pigments, dyes, and mixtures and combinations thereof.

13. The process of claim 1, further comprising:
providing an additional surfactant comprising a surfactant containing a sodium salt counter-ion; and
wherein the additional surfactant is provided in an amount of less than about 5 percent by weight based on the total weight of the dispersion or emulsion.

14. A process for preparing a toner comprising:
forming an emulsion comprising a resin and alkyl benzene sulfonate surfactant having an ammonium salt counter ion, wherein the alkyl benzene sulfonate surfactant is substantially free of sodium salt counter ions such that the sodium content of the alkyl benzene sulfonate surfactant is less than about 5,000 parts per million;
combining the emulsion with an optional additional resin, a colorant, and an optional wax, with a coagulant to form a homogenized toner slurry comprising pre-aggregated particles at room temperature;
heating the slurry to form aggregated toner particles;
freezing the toner slurry once at the desired aggregated particle size; and
further heating the aggregated particles in the slurry to coalesce the aggregated particles into toner particles.

15. The process of claim 14, wherein the alkyl benzene sulfonate surfactant having an ammonium salt counter ion is a compound of the formula 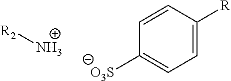
wherein R is hydrogen or an alkyl group having from about 1 to about 100 carbon atoms; and
wherein R₂ is hydrogen or an alkyl group having from about 1 to about 100 carbon atoms.

16. The process of claim 14, wherein the resin comprises an amorphous polyester resin, a crystalline polyester resin, or a combination thereof.

17. The process of claim 14, wherein the optional wax comprises a wax dispersion prepared by contacting an alkyl benzene sulfonate surfactant having an ammonium salt counter ion with a wax, wherein the alkyl benzene sulfonate surfactant is substantially free of sodium salt counter ions such that the sodium content of the alkyl benzene sulfonate surfactant is less than about 5,000 parts per million, and water, and using the alkyl benzene sulfonate surfactant to disperse the wax and form the wax dispersion; and
optionally, providing an additional surfactant comprising a surfactant containing a sodium salt counter-ion wherein the additional surfactant is provided in an amount of less than about 5 percent by weight based on the total weight of the wax dispersion.

18. The process of claim 14, wherein the colorant comprises a colorant dispersion prepared by contacting an alkyl benzene sulfonate surfactant having an ammonium salt counter ion with a colorant comprising a pigment, a dye, or a combination thereof, wherein the alkyl benzene sulfonate surfactant is substantially free of sodium salt counter ions such that the sodium content of the alkyl benzene sulfonate surfactant is less than about 5,000 parts per million, and using the alkyl benzene sulfonate surfactant to disperse the colorant and form a colorant dispersion; and
optionally, providing an additional surfactant comprising a surfactant containing a sodium salt counter-ion wherein the additional surfactant is provided in an amount of less than about 4 percent by weight based on the total weight of the colorant dispersion.

19. A process for preparing an emulsifiable resin comprising:
contacting a resin with an alkyl benzene sulfonate surfactant having an ammonium salt counter ion, wherein the alkyl benzene sulfonate surfactant is substantially free of sodium salt counter ions such that the sodium content of the alkyl benzene sulfonate surfactant is less than about 5,000 parts per million, a neutralizing agent, and, optionally, water, in the absence of an organic solvent to form a mixture;
melt mixing the mixture; and
forming an emulsifiable resin from the melt mixed mixture;
optionally, adding water to the emulsifiable resin to provide a latex emulsion containing latex particles; and
optionally, continuously recovering the latex particles.

20. The process of claim 19, wherein the alkyl benzene sulfonate surfactant is a compound of the formula 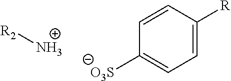
wherein R is hydrogen or an alkyl group having from about 1 to about 100 carbon atoms; and
wherein R₂ is hydrogen or an alkyl group having from about 1 to about 100 carbon atoms.
